(19) United States
(12) Patent Application Publication
(10) Pub. No.: US 2004/0216966 A1
(43) Pub. Date: Nov. 4, 2004

(54) Disc brake

(76) Inventors: Joakim Gripemark, Helsingborg (SE); Tony Borg, Glumslov (SE)

Correspondence Address: ST. ONGE STEWARD JOHNSTON & REENS, LLC, 986 BEDFORD STREET, STAMFORD, CT, 06905-5619, US

(21) Appl. No.: 10/750,400

(22) Filed: Dec. 31, 2003

Related U.S. Application Data
(63) Continuation of application No. PCT/SE03/04897, filed on Jul. 1, 2002.

(30) Foreign Application Priority Data
Jul. 2, 2001 (SE) 0102348-0

(51) Int. Cl. F16D 55/00

(52) U.S. Cl. 188/71.1

(57) ABSTRACT

The present invention concerns a disc brake comprising a caliper, a brake disc and one or more brake pads received in a pad holder. The brake disc and pad holder are axially moveable in relation to the caliper. The brake disc is coated with a brake lining material on one side. On the other side of the brake disc there is no brake lining. The caliper is designed having cooling flanges extending over a part of the brake lining of the caliper.

This application is a continuation of pending International Patent Application No. PCT/SE02/01296 filed Jul. 1, 2002 which designates the United States and claims priority of pending Swedish Application No. 0102348-0 filed Jul. 1, 2001.

### FIELD OF INVENTION

The present invention concerns a disc brake mainly for heavy and light duty trucks, busses, trailers and the like, but is applicable for any vehicle. The invention is mainly directed to the disc of the disc brake, but also concerns the design of the brake caliper.

### BACKGROUND OF INVENTION

Disc brakes of varying kind are known. The present invention is developed mainly for disc brakes having a fixed caliper. However, a person skilled in the art realises that it is also applicable for disc brakes having a sliding caliper. In disc brakes having a fixed caliper the braking is normally accomplished by means of brake pads on both sides of the brake disc going into contact with the brake disc. Depending on the design of the brake the disc or discs are either fixed or arranged axially moveable in relation to the caliper, or rather the wheel axle. One problem with the disc brakes of prior art is how the heat produced during braking is distributed and dissipated. If the heat is not distributed in a suitable way the heat may damage different parts of the brake.

### SUMMARY OF INVENTION

There is a constant strive to have disc brakes taking up as little space as possible and that have as low weight as possible. Furthermore, the disc brake should be easy to maintain and thus to change parts that wear. As indicated above it is important to reflect on the distribution of heat in the disc brake.

Thus, one object of the present invention is to reduce the width of the disc brake.

A further object is to distribute the heat produced during braking in such a way, that the brake mechanism and the brake disc are protected in as large extent as possible.

The above objects are met by a disc brake comprising a caliper, a brake disc and a brake pad received in a pad holder. The brake disc and pad holder are axially moveable in relation to the caliper. The brake disc is furnished with a brake lining material on one side.

By placing the lining material all around one side of the brake disc the same braking capacity is retained, while the total width of the lining material and the brake pad is less than the total width of two brake pads, arranged on both sides of the disc. A brake pad is normally only acting on a part of the brake disc, while a brake disc having a brake lining material on one side may be active along a full circle ring. Thus, it is possible to have the same effect with a thinner lining material on the disc as compared to the thickness of a brake pad.

Furthermore, the brake caliper may be formed in such a way that the heat produced in breaking is distributed in a suitable way. Thus, the caliper is formed to lead off as much heat as possible.

Further objects and advantages with the present invention will be obvious for a person skilled in the art when reading the detailed description below of a preferred embodiment.

### BRIEF DESCRIPTION OF DRAWINGS

The invention will be described more closely below with reference to the enclosed drawings. In the drawings,

FIG. 1 is a perspective view of a caliper, brake disc and pad holder of the disc brake of the invention,

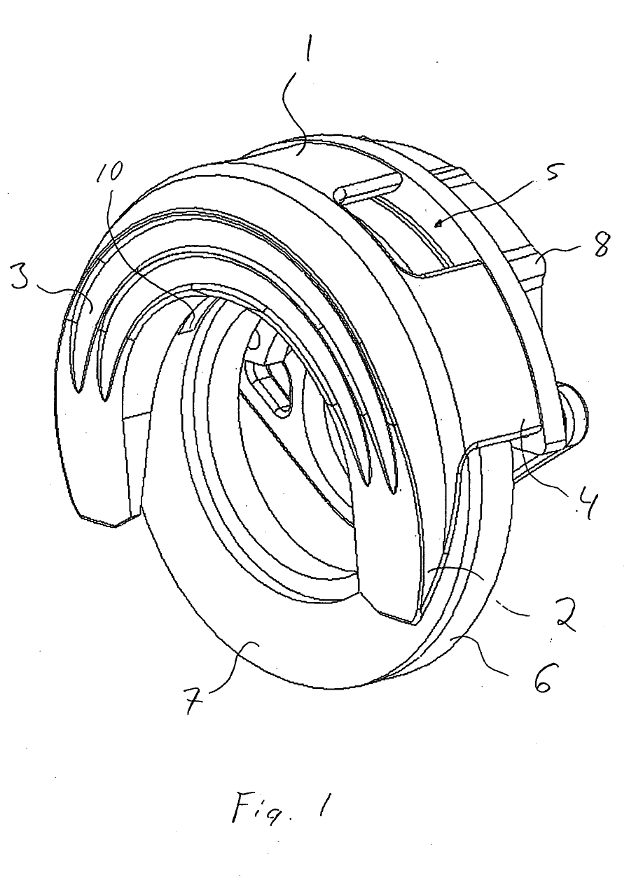

FIG. 2 is a perspective view of the parts of FIG. 1 from the opposite directions, and

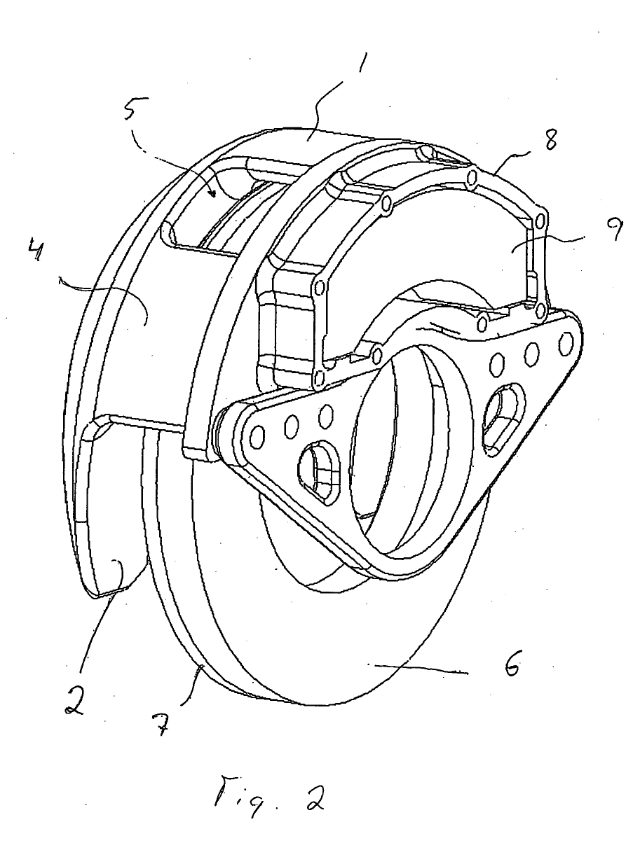

FIG. 3 is a sectional view in perspective of the parts of FIGS. 1 and 2.

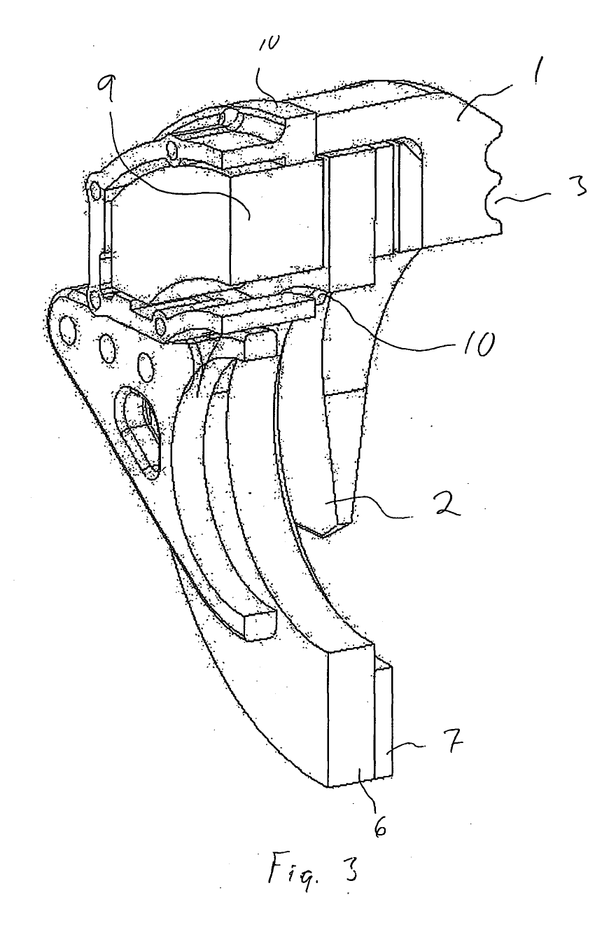

### DETAILED DESCRIPTION OF PREFERRED EMBODIMENT

In the enclosed drawings parts of a disc brake are shown schematically. The shown parts are a caliper 1, a brake pad holder 8 and a brake disc 6.

The brake disc 6 is normally received by means of the central opening on a hub or the like (not shown). Some kind of brake mechanism (not shown) is acting on the pad holder 8. But as the attachment to the hub or the like and the brake mechanism as such form no part of the present invention they will not be described further here.

The caliper 1 has the general form of a part of a circle. The brake disc 6 is placed inside the caliper 1, with the upper part of the brake disc 6 surrounded by the caliper 1. The caliper 1 is attached to the pad holder by means of a number of anchor parts 4. The caliper 1 has openings 9 between said anchor parts 4. The anchor parts 4 cross the imaginary plane in which the brake disc 6 is placed. Even tough the caliper 1 has three anchor parts 4 in the shown embodiment a person skilled in the art realises that any number of anchor parts 4 may be arranged. Furthermore, the caliper 1 has cooling flanges 2 at the lower ends of the part circle. On the side opposite the brake disc the caliper 1 is furnished with a number of grooves 3 following the curvature of the part circle.

The caliper 1 is formed to have a good cooling effect. The openings 9 between the anchor parts 4 and the grooves 3 of the cooling flanges 2 assist in giving a good cooling effect.

The brake disc 6 is received on a hub or the like displaceable in relation to the caliper 1. On the side of the brake disc 6 facing the cooling flanges 2 of the caliper 1 a brake lining material 7 is furnished. The brake lining 7 is placed as a coating or in any other suitable way on the brake disc 6 and extends the full circle (or rather circle ring) of the brake disc 6. In other embodiments (not shown) the brake lining material is divided into two or more circle ring segments extending a full circle ring. On the opposite side of the brake disc 6 there is no brake lining 7.

A wearing part 10 is placed in the caliper 1 facing the brake lining 7 of the brake disc 6. In braking the wearing part 10 will go into contact with the brake lining 7 of the brake disc 6. The wearing part 10 is normally received in a recess of the caliper 1. The wearing part 10 is normally not fixed in the recess, but is kept in place in that the thickness of the wearing part 10 exceeds the distance between the brake lining 7 and the caliper 1. In alternative embodiments the wearing part 10 is fixed to the caliper 1 by means of glue or the like. The wearing part 10 may still be placed in a recess of the caliper 1, but in other embodiments it is fixed directly to the wall.

The pad holder 8 holds a brake pad 9 in the normal way. As different pad holders are known to a person skilled in the art and the exact form of the holder is of minor concern for the invention it will not be described further here. The pad holder 8 holding one or more brake pads 9 is arranged on that side of the brake disc 6 having no brake lining material 7.

In braking the brake mechanism (not shown) will press the brake pad 9 towards the brake disc 6. This will move the brake disc 6, which is received slideable on a hub or the like. Thus the lining material 7 of the brake disc 6 will go into contact with the wearing part 10. The actual braking takes place between the lining material 7 of the brake disc 6 and the wearing part 10 and between the opposite side of the brake disc 6 and the brake pad 9 of the pad holder 8, respectively.

The caliper 1 follows the form of the brake disc 6 at the side of the brake disc 6 having the lining material 7. The caliper 1 is extended over about half of the circumference of the brake disc 6. Due to the design of the brake caliper 1 and the fact that one side of the brake disc 6 is furnished with brake lining 7, a major part of the heat generated during breaking will be taken up by the caliper 1 and, thus, only a minor part of the heat will be taken up by the brake pad holder 8. This will protect the brake mechanism from excessive heating.

The lining material has lower thermal conductivity than the caliper 1 and brake disc 6, respectively. This means that in the contact between the lining material 7 and the caliper 1 most of the heat will be distributed to the caliper 1 in braking. This will protect the brake disc 6 from overheating. On the other side of the brake disc most of the heat will be distributed to the disc 6, as for all brakes having a brake pad in contact with a brake disc.

1. A disc brake comprising a caliper, a brake disc and one or more brake pads received in a pad holder, which brake disc and pad holder are axially moveable in relation to the caliper, characterized in that the brake disc is furnished with a brake lining material on one side and that there is no brake lining on the other side of the brake disc.

2. The disc brake of claim 1, characterized in that the brake lining is coated on the brake disc and extends a full circle ring on the brake disc.

3. The disc brake of claim 1, characterized in that the brake lining is divided into two or more circle ring segments extending a full circle ring on the brake disc.

4. The disc brake of claim 1, characterized in that the pad holder is arranged on the side of the brake disc having no brake lining.

5. The disc brake of claim 1, characterized in that the caliper has cooling flanges extending over a part of the brake lining of the brake disc and that one or more grooves are arranged on the cooling flanges of the caliper.

6. The disc brake of claim 1, characterized in that one or more wearing parts are placed in the caliper for contact with the brake lining of the brake disc during braking and/or that the wearing part(s) is received in a recess of the caliper.

7. The disc brake of claim 6, characterized in that the wearing part is fixed to the caliper.

8. The disc brake of any of the previous claims claim 1, characterized in that the caliper has anchor parts in which the pad holder is fixed to the caliper.

9. The disc brake of claim 8, characterized in that the anchor parts of the caliper cross the plane of the brake disc.

10. The disc brake of claim 8, characterized in that the anchor parts are arranged at a distance from each other forming openings in the caliper.
